(19) United States
(12) Patent Application Publication
(10) Pub. No.: US 2012/0191628 A1
(43) Pub. Date: Jul. 26, 2012

(54) IP SERVICE PEERING MECHANISMS

(75) Inventor: Michael K. Bugenhagen, Overland Park, KS (US)

(73) Assignee: EMBARQ HOLDINGS COMPANY, LLC

(21) Appl. No.: 13/012,053

(22) Filed: Jan. 24, 2011

(51) Int. Cl. G06F 15/173; G06F 17/00

(52) U.S. Cl. 705/400; 709/224

(57) ABSTRACT

Embodiments of the disclosed invention include an apparatus, method, and computer program product for providing advanced IP Service Peering is disclosed. In one embodiment, the method includes identifying a source and a content type associated with a data packet communicated from a first network to a peer network; determining whether the source is a registered peer service; identifying a quality of service level associated with the source in response to a determination that the source is a registered peer service; dynamically marking the data packet associated with the source with the quality of service level; and transmitting the data packet to the peer network, wherein the peer network communicates the data packet based on the quality of service level associated with the data packet.

### FIELD OF THE INVENTION

Embodiments of the present invention generally relate to a method and apparatus for controlling network traffic flow. More specifically, embodiments of the invention provide advanced internet protocol (IP) service peering mechanisms for dynamically authenticating, controlling, and billing for network traffic flow between network access service providers.

### BACKGROUND

Peering is the arrangement of traffic exchange between Internet service providers (ISPs). Larger ISPs with their own backbone networks agree to allow traffic from other large ISPs in exchange for traffic on their backbones. They also exchange traffic with smaller ISPs so that they can reach regional end points. Essentially, this is how a number of individual network owners put the Internet together. To do this, network owners and access providers, the ISPs, work out agreements that describe the terms and conditions to which both are subject.

### SUMMARY OF THE INVENTION

The disclosed embodiments include a method, apparatus, and computer program product for dynamically authenticating, controlling, and billing for network traffic flow between peering network access service providers. For example, the disclosed embodiments include a computer program product comprising a computer usable medium having a computer readable program code embodied therein, said computer readable program code comprising instructions to: identify a source and a content type associated with a data packet communicated from a first network to a peer network; determine whether the source is a registered peer service; identify, using a registered quality of service peer table, a quality of service level associated with the source in response to a determination that the source is a registered peer service; dynamically mark the data packet associated with the source with the quality of service level; mark the data packet with a user network identifier, wherein the user network identifier is utilized by the peer network to automatically authenticate the source of the data packet; map the data packet to a service point of the peer network using the user network identifier; transmit the data packet to the peer network, wherein the peer network communicates the data packet based on the quality of service level associated with the data packet; monitor an amount of data associated with the source being communicated by the first network; store the amount in a peer usage tracking table, wherein the quality of service level associated with the source dynamically changes in response to the amount stored in the peer usage tracking table exceeding a first predetermined threshold; and calculate a cost associated with the amount of data associated with the source being communicated by the first network based on a cost per unit associated with the source, the cost per unit being stored in the peer usage tracking table, wherein the cost per unit associated with the source dynamically changes in response to the amount of data associated with the source exceeding a second predetermined threshold.

In another embodiment, a computer implemented method for providing advanced IP Service Peering is disclosed. In one embodiment, the method includes identifying a source and a content type associated with a data packet communicated from a first network to a peer network; determining whether the source is a registered peer service; identifying a quality of service level associated with the source in response to a determination that the source is a registered peer service; dynamically marking the data packet associated with the source with the quality of service level; and transmitting the data packet to the peer network, wherein the peer network communicates the data packet based on the quality of service level associated with the data packet.

Still, in another embodiment, an apparatus for providing advanced IP Service Peering is disclosed. The apparatus includes memory for storing data and executable instructions; a network interface for communicating with at least one network; and a processing unit. The processing unit is operable to execute the executable instructions to identify a source and a content type associated with a data packet communicated from a first network to a peer network; determine whether the source is a registered peer service; identify, using a registered quality of service peer table, a quality of service level associated with the source in response to a determination that the source is a registered peer service; dynamically mark the data packet associated with the source with the quality of service level; transmit the data packet to the peer network, wherein the peer network communicates the data packet based on the quality of service level associated with the data packet; monitor an amount of data associated with the source being communicated by the first network; store the amount in a peer usage tracking table; and calculate a cost associated with the amount of data associated with the source being communicated by the first network based on a cost per unit associated with the source, the cost per unit being stored in the peer usage tracking table.

### BRIEF DESCRIPTION OF THE DRAWINGS

Illustrative embodiments of the present invention are described in detail below with reference to the attached figures, which are incorporated by reference herein and wherein:

FIG. 1 depicts an embodiment of a network environment in which certain illustrative embodiments may be implemented;

FIG. 2 depicts an embodiment of an IP service controller in accordance with certain embodiments of the invention;

FIG. 3 depicts an embodiment of a registered peer table in accordance with certain embodiments of the invention;

FIG. 4 depicts another embodiment of a peer usage tracking table as in accordance with certain embodiments of the invention; and

FIG. 5 depicts an embodiment of a peering gateway in accordance with certain embodiments of the invention.

### DETAILED DESCRIPTION

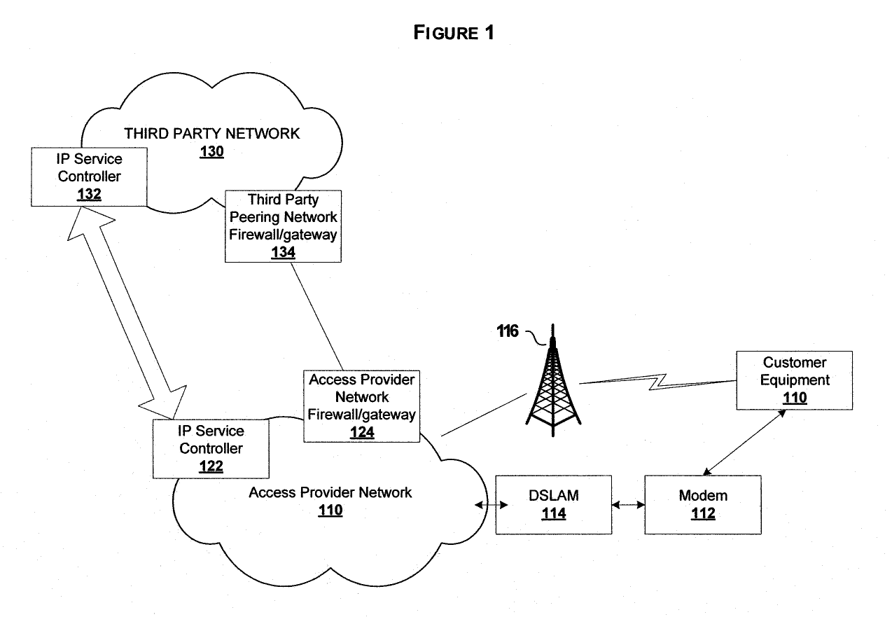

The disclosed embodiments and advantages thereof are best understood by referring to FIGS. 1-5 of the drawings, like numerals being used for like and corresponding parts of the various drawings. Other features and advantages of the disclosed embodiments will be or will become apparent to one of ordinary skill in the art upon examination of the following figures and detailed description. It is intended that all such additional features and advantages be included within the scope of the disclosed embodiments. Further, the illustrated figures are only exemplary and are not intended to assert or imply any limitation with regard to the environment, architecture, design, or process in which different embodiments may be implemented.

FIG. 1 depicts an embodiment of a network environment 100 in which certain illustrative embodiments may be implemented. The network environment 100 includes an access provider 120 which provides network access to a customer equipment 110. The customer equipment 110 may be representative of an individual user's device and/or may represent a plurality of devices of one or more organizations. The customer equipment 110 may include any type of device with network capabilities for communicating with the access provider 120. For example, the customer equipment 110 may include mobile handheld computing and/or communication devices with wireless Internet capabilities. Additionally, the customer equipment 110 may include laptops, desktop computers, network servers, set-top boxes, televisions, and/or any other electronic devices with network capabilities.

The customer equipment 110 may communicate with the access provider 120 via a wired or wireless means. For example, in one embodiment, the customer equipment 110 may be hard-wired to a modem/router 112, which in turn is hard-wired to a Digital Subscriber Line Access Multiplexer (DLSAM) 114. The DLSAM 114 is typically located at a telephone exchange of the service provider. The DLSAM 114 connects multiple customer Digital Subscriber Lines (DSLs) to a high-speed Internet backbone line for enabling communication between the customer equipment 110 and the access provider 120. Of course, the customer equipment 110 may communicate with the access provider 120 using other types of wired communication such as, but not limited to, fiber-optic lines. In addition, in some embodiments, the customer equipment 110 may communicate with the access provider 120 wirelessly via one or more cellular communication towers 116 using any type of wireless network such as, but not limited to, one or more GSM networks, CDMA networks, Enhanced Data GSM Environment (EDGE) networks, PSTN networks, and 3G/4G networks.

The access provider 120 provides network access such as Internet access, e-mail services, or any of the type of network services to the customer equipment 110. As part of providing the network access to the customer equipment 110, the access provider 120 may communicate data packets associated with the customer equipment 110 over one or more third-party/peer networks, such as, but not limited to, peer network 130. The communication of data packets between the access provider 120 and the peer network 130 is controlled by a service controller within each respective network. For example, the access provider 120 may include an IP service controller 122 that communicates with a third party IP service controller 132 of the peer network 130 for enabling communication of data between the two networks.

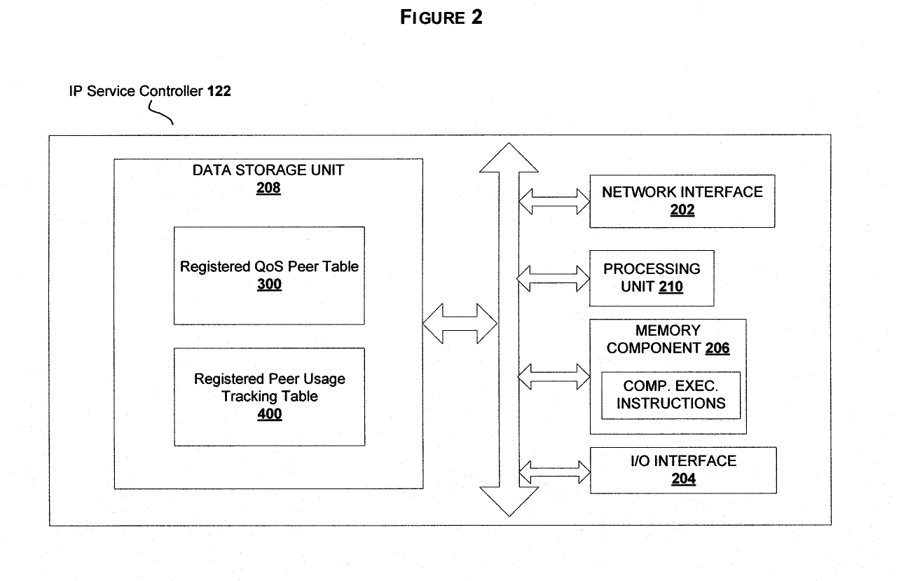

As shown in FIG. 2, the IP service controller 122 includes at least one or more network interfaces, input/output interfaces, memory components, data storage units, and processors for storing and executing instructions for enabling the IP service controller 122 to dynamically manage and control network services such as video streaming, VOIP, web browsing, and other applications. The IP service controller 122 includes user policy and session control, in addition to, enhanced Home Subscriber Server (HSS), Home Location Register (HLR), Session Initiation Protocol (SIP) Proxy Servers, and user service point (SP) mapping functions.

Additionally, in one embodiment, the IP service controller 122 uses deep and shallow packet inspection to understand user data activity in perspective of service destination/source, service type or application content (Layer 7/8), protocols, bandwidth occupied, current location and traffic patterns. Deep packet inspection (DPI) is the ability to examine the application payload of a data packet or traffic stream to identify the content of the data and make decisions on the significance of that data. For instance, in certain embodiments, the IP service controller 122 uses deep packet inspection for identifying data and dynamically assigning a quality of service (QoS) level to each data packet passing through the access provider 120 network. For example, in one embodiment, the IP service controller 122 dynamically marks each data packet communicated between the access network provider and the one or more third-party networks with a QoS marking based on QoS flow parameters for specific types of inbound and outbound traffic flows associated with each peering/partnered company (e.g., a cable company or web-media provider). The IP service controller 122 may store the QoS flow parameters in a registered QoS peer table 300, which is used by the IP service controller 122 for registration of peer service sources. In addition, the IP service controller 122 is able to initiate charging, monitor quotas, invoke dialogue, redirect, filter traffic, allow/deny service access, and control bandwidth per subscriber, peer network, and/or customer equipment with minimum and maximum rates utilizing a registered peer usage tracking table 400.

Alternatively, in some embodiments, the IP service controller 122 transmits all or a portion of the data from the registered QoS peer table and the registered peer usage tracking table to all IP network peering gateways and all pin-hole firewalls to enable the Dynamic or Static QoS marking mechanisms to be configured in the inter-connection elements. For example, FIG. 1 depicts an access provider network firewall/gateway 124 and a third party peering network firewall/gateway 134 configured to provide access to each respective network for enabling communication of data packets between the access provider 120 network and the peer network 130. The access provider network firewall/gateway 124 and the third party peering network firewall/gateway 134 includes hardware components such as, but not limited to, I/O interface components, network interface components, memory, data storage components, and at least one processing component for storing and executing instructions (hardware components not depicted in FIG. 1).

For example, in one embodiment, the access provider network firewall/gateway 124 and the third party peering network firewall/gateway 134 are configured as specialized User Datagram Protocol (UDP) firewalls with Broadband Remote Access Server (BRAS) functions. UDP is a set of network protocols used for the Internet. With UDP, computer applications can send messages, in this case referred to as datagrams, to other hosts on an Internet Protocol (IP) network without requiring prior communications to set up special transmission channels or data paths. The BRAS functions provides aggregation capabilities (e.g. IP, PPP, ATM) between the access provider 120 network and the one or more third party networks, such as peer network 130. The access provider network firewall/gateway 124 and third party peering network firewall/gateway 134 are also the injection point for policy management and IP QoS in the respective access networks.

Additionally, in certain embodiments, the access provider network firewall/gateway 124 and the third party peering network firewall/gateway 134 may be configured to perform DPI based QoS marking and IP Detail Record (IPDR) based billing using data from the registered QoS peer table 300 and the registered peer usage tracking table 400 (depicted in FIG. 2). For example, the billing attributes configuration of the registered peer usage tracking table 400 is used to configured data usage tracking by the access provider network firewall/gateway 124 and the third party peering network firewall/gateway 134 for billing purposes.

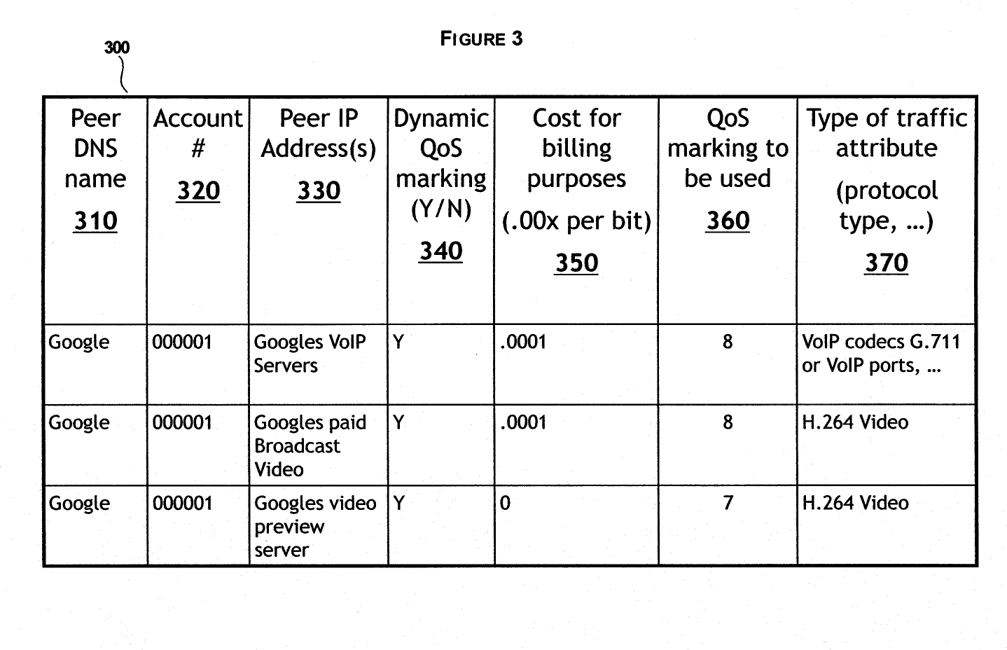

FIG. 3 depicts an embodiment of the registered peer table 300 in accordance with certain embodiments of the invention. In the depicted embodiment, the registered peer table 300 includes the following column attributes: a peer Domain Name System (DNS) name attribute 310, an account number attribute 320, a peer IP address attribute 330, a dynamic QoS marking indicator attribute 340, a cost attribute 350, a QoS marketing attribute 360, and a traffic type attribute 370. The peer DNS name attribute 310 contains the domain name of the partnered/peer service (e.g., Google™). The account number attribute 320 is an account number associated with the particular partnered service. The peer IP address attribute 330 identifies the particular device of the partnered service on the Internet using the IP address of the device. The dynamic QoS marking indicator attribute 340 is a setting that indicates whether dynamic QoS is to be applied to the particular partnered service. The cost attribute 350 specifies the cost per bit (or any other size of data) that are communicated by the particular partnered service over the access provider 120 network. The QoS marketing attribute 360 indicates the QoS marking to be used for the particular partnered service. Finally, the traffic type attribute 370 indicates attributes (e.g., protocol type, ports, etc.) associated with type of data transmitted by the particular partnered service.

Using the registered QoS peer table 300, the access provider network firewall/gateway 124 may recognize data coming from or transmitted to the particular partnered service (e.g., using shallow and/or deep packet inspection). Upon identifying outbound or inbound data packets associated with the particular partnered service, the access provider network firewall/gateway 124 checks the registered QoS peer table 300 to determine whether to apply dynamic QoS marking to the data packets associated with the particular partnered service and if so, which type of QoS marking to apply. Additionally, the registered QoS peer table 300 may be used to apply different billing and different QoS levels on a deeper level than merely differentiating between real-time and non-real-time content. For instance, as indicated in the disclosed embodiment, if the data packet is identified, based on the stored IP address, to be associated with Google's™ paid video broadcast, then a billing cost of 0.0001 is applied per bit and a QoS level of 8 is applied to the data packet. However, if the data packet is identified, based on the stored IP address, to be associated with Google's™ free preview server, then no billing cost is applied to this particular data and a lower QoS level (e.g., 7) is applied to this particular data packet.

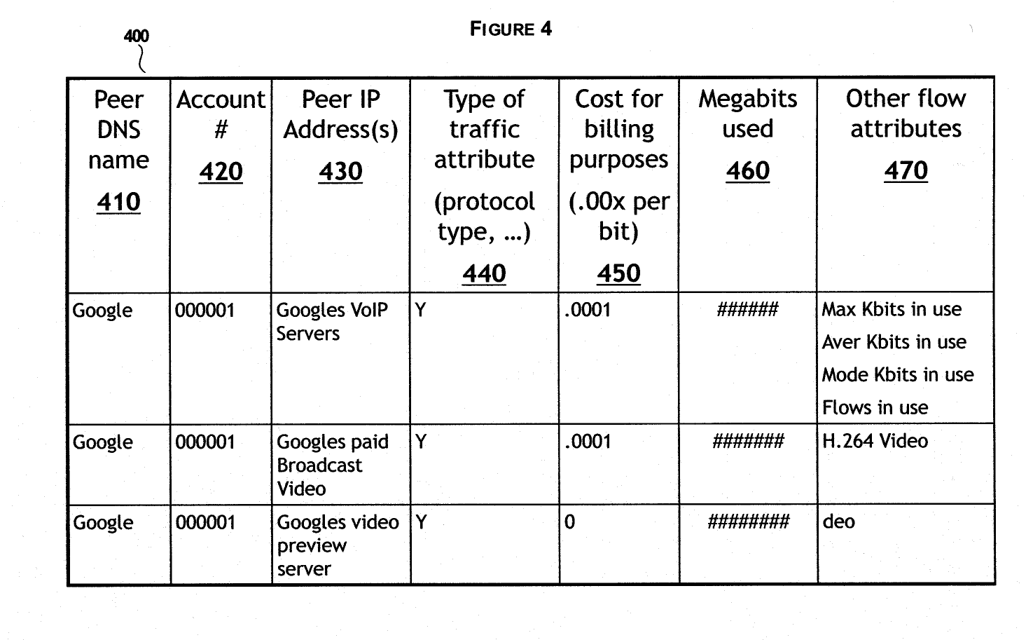

FIG. 4 depicts an embodiment of the peer usage tracking table 400 in accordance with certain embodiments of the invention. In the depicted embodiment, the peer usage tracking table 400 includes a peer DNS name attribute 410, an account number attribute 420, a peer IP address attribute 430, a traffic type attribute 440, and a cost attribute 450 that are similar to the respective attributes discussed above with respect to the registered peer table 300. The access provider network firewall/gateway 124 uses the data in the registered peer usage tracking table 400 to bill for the amount of data communicated between the access provider 120 network and the particular partnered service. For example, the peer usage tracking table 400 includes a traffic amount attribute 460 and a miscellaneous flow attribute 470. The traffic amount attribute 460 stores the amount of data (e.g., megabits) that is communicated between the access provider 120 network and the particular partnered service. The access provider network firewall/gateway 124 and/or the IP service controller 122 utilizes this data and the cost attribute 450 data to calculate a billing cost associated with the particular partnered service.

The miscellaneous flow attribute 470 includes other attributes that may be used in calculating the cost for a particular partnered service based on a service agreement between the access provider 120 and the particular partnered service. For example, the miscellaneous flow attribute 470 may include such information as, but not limited to, max Kbits in use, average Kbits in use, mode Kbits in use, flows in use, and the type of video encoding. In one embodiment, the miscellaneous flow attribute 470 may indicate a max threshold data amount that if crossed, would dynamically adjusts the cost attribute 450 and/or the QoS marketing attribute 360 in the registered QoS peer table 300. For example, if the amount of data indicated by the traffic amount attribute 460 exceeds the max threshold data amount, the cost attribute 450 amount may increase to, or by, a pre-specified amount and/or the QoS marketing attribute 360 level may decrease for the particular partnered service. As an example, if the amount of data indicated by the traffic amount attribute 460 exceeds the max threshold data amount for data associated with Google's™ free preview server, then the cost attribute 450 may increase from 0 to 0.0001 per bit for data exceeding the threshold amount for a given time period.

Additionally, because the data associated with the registered QoS peer table 300 and the registered peer usage tracking table 400 is also transmitted to all the third party peering network inter-connection elements (e.g., third party peering network firewall/gateway 134), all third party peering networks may use the same data for monitoring communications associated with a particular partnered service that are communicated over the third party peering network. Further, the third party peering network may use the data to dynamically authenticate the data packet associated with the particular partnered service as being associated with the access provider 120 for enabling the data packets associated with the particular partnered service to be communicated over the third party peering network without requiring additional authentication. Moreover, the third party peering network may apply the same QoS level as indicated in the registered QoS peer table 300 for providing a quality of service to the data packet associated with the particular partnered service through the third party peering network.

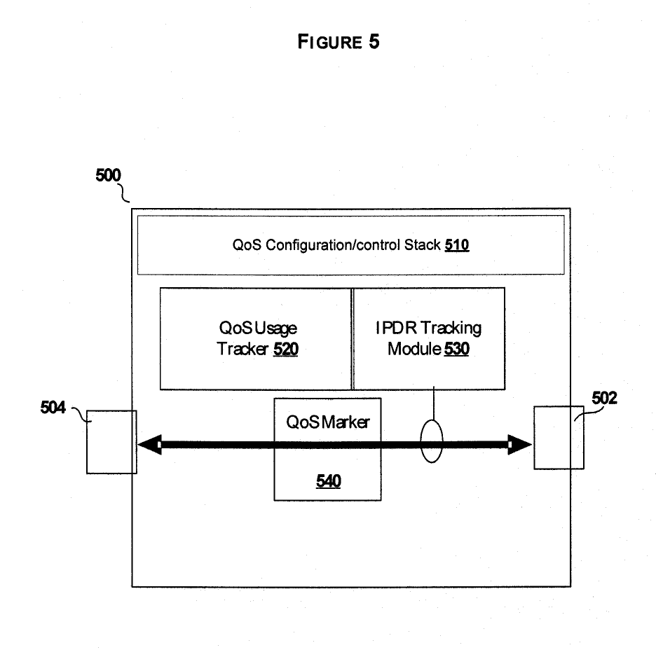

FIG. 5 depicts an embodiment of the functional components of a peering gateway 500 such as, the access provider network firewall/gateway 124 of the access provider 120 network and/or the third party peering network firewall/gateway 134 of the peer network 130, in accordance with certain embodiments of the invention. As stated above, the peering gateway 500 includes hardware components such as, but not limited to, I/O interface components, network interface components, memory, data storage components, and at least one processing component for storing and executing instructions for providing advanced traffic flow control and billing services (hardware components not depicted in FIG. 5). For example, the peering gateway 500 includes a network interface 502 connecting the peering gateway 500 to a first access network (e.g., the peer network 130) and a network interface 504 connecting the peering gateway 500 to a second access network (e.g., the access provider 120). The peering gateway 500 provides a connection or an access point for enabling data to be transmitted between the first and the second access network.

Additionally, in the depicted embodiment, the peering gateway 500 includes, among other things, a QoS configuration/control stack 510, a QoS usage tracker 520, an IPDR tracking module 530, and a QoS marker module 540. In one embodiment, the QoS configuration/control stack 510 stores the QoS configuration settings for the peering gateway 500. In addition, the QoS configuration/control stack 510 may include one or more buffer queues for storing data packets to be processed and/or to be transmitted. The priority of the data packets to be processed and/or to be transmitted by the peering gateway 500 may be based at least on a QoS marking, if any, associated with the data packets.

The QoS usage tracker 520 monitors the traffic flow and keeps an accounting of the QoS usage for each of the partnered services. For example, the QoS usage tracker 520 may update the registered peer usage tracking table 400 with the number of bits in the traffic amount attribute 460 for each partnered service. In addition, in certain embodiments, the QoS usage tracker 520 may monitor the number of bits associated with a particular priority status (e.g., 8) for a particular partnered service. For example, in some embodiments, a particular partnered service may be limited by the number of bits at a particular priority level that may pass through the peering gateway 500. In such embodiments, the data packets associated with particular partnered service exceeding the threshold may be transmitted at a lower priority (e.g., a lower set priority or using best effort), transmitted at a higher cost, transmitted based on bandwidth availability (e.g., if bandwidth permits, the priority level may stay the same), and/or the peering gateway 500 may block communications of the data packets exceeding the threshold.

Further, in some embodiments, a partnered service may purchase additional priority credits. For example, in one embodiment, the IP service controller 122 may be linked to web server (not depicted), which stores and executes instructions for providing a web interface to a partnered service (or other users) for enabling the purchase of additional priority credits. Additionally, the web interface may be used to configure settings associated with the peering gateway 500 including, but not limited to, setting the cost, priority level, and threshold values associated with partnered services.

The IPDR tracking module 530 utilizes the IPDR protocol to enable the collection of usage data from variety of devices to provide additional information or revenue generating opportunities. For example, in one embodiment, the IPDR tracking module 530 utilizes the data monitored by the QoS usage tracker 520 to generate a detailed record for each of the partnered service. The detailed record provides information about service usage and other activities that can be used by the Operational Support Systems (OSS) and the Business Support Systems (BSS). For instance, the detailed record may be utilized for billing the partnered services.

The QoS marker module 540 includes instructions for dynamically marking data packets with a QoS level as it passes through the peering gateway 500. For example, in some embodiments, the QoS marker module 540 may mark a data packet with a particular QoS level if the data packet does not include any QoS marking. Additionally, the QoS marker module 540 may decrease and/or increase an existing QoS marking for data packets associated with a particular partnered service. For example, in one embodiment, a particular partnered service may have a higher QoS level for data packets communicated in the access provider 120 network. However, the particular partnered service may have a lower QoS level for the same data packets as they are communicated over one or more of the third party peer networks such as peer network 130. Thus, the QoS marker module 540 enables dynamic assignment/adjustments of the QoS level as it passes between the peer networks. In alternative embodiments, the functions disclosed above may be performed further inside the network by other devices, as opposed to being performed directly at the peering gateway 500.

The disclosed embodiments enables the virtual sale of the IP Network by dynamically QoS marking “partner” or “peer” traffic based on the type of traffic and billing based the QoS marking. Additionally, the disclosed embodiments enable mapping of the customer to a third party service point and automatic authentication of customers on one or more third party networks. For instance, in one embodiment, the networks “agree” to authenticate users based on a user network identifier, which also provides a “service point” mapping so that a user can authenticate on a third party access provider network. The user is then mapped to an out of franchise provider via a “user session and control policy” message. For example, in one embodiment, the return message from the service provider indicates what network to network QOS markings to apply and the switch/gateway maps the customer to the third party and applies the QOS markings. Accordingly, the above disclosure describes several embodiments for providing advanced Internet protocol UP) service peering for dynamically authenticating, controlling, and billing for network traffic flow between network access service providers.

The illustrative embodiments can take the form of an entirely hardware embodiment, an entirely software embodiment or an embodiment containing both hardware and software elements. Furthermore, the illustrative embodiments can take the form of a computer program product accessible from a computer-usable or computer-readable medium providing program code for use by or in connection with a computer or any instruction execution system. For the purposes of this description, a computer-usable or computer-readable medium can be any tangible apparatus that can contain, store, communicate, or transport the program for use by or in connection with the instruction execution system, apparatus, or device. The previous detailed description discloses several embodiments for implementing the invention and is not intended to be limiting in scope. Those of ordinary skill in the art will recognize obvious variations to the embodiments disclosed above and the scope of such variations are intended to be covered by this disclosure. The following claims set forth the scope of the invention.

We claim:

1. A computer program product comprising a computer usable medium having a computer readable program code embodied therein, said computer readable program code comprising instructions to:
identify a source and a content type associated with a data packet communicated from a first network to a peer network;
determine whether the source is a registered peer service;
identify, using a registered quality of service peer table, a quality of service level associated with the source in response to a determination that the source is a registered peer service;
dynamically mark the data packet associated with the source with the quality of service level;
mark the data packet with a user network identifier, wherein the user network identifier is utilized by the peer network to automatically authenticate the source of the data packet;
map the data packet to a service point of the peer network using the user network identifier;
transmit the data packet to the peer network, wherein the peer network communicates the data packet based on the quality of service level associated with the data packet;
monitor an amount of data associated with the source being communicated by the first network;
store the amount in a peer usage tracking table, wherein the quality of service level associated with the source dynamically changes in response to the amount stored in the peer usage tracking table exceeding a first predetermined threshold; and
calculate a cost associated with the amount of data associated with the source being communicated by the first network based on a cost per unit associated with the source, the cost per unit being stored in the peer usage tracking table, wherein the cost per unit associated with the source dynamically changes in response to the amount of data associated with the source exceeding a second predetermined threshold.

2. A computer implemented method for providing advanced IP Service Peering, the method comprising:
identifying a source and a content type associated with a data packet communicated from a first network to a peer network;
determining whether the source is a registered peer service;
identifying a quality of service level associated with the source in response to a determination that the source is a registered peer service;
dynamically marking the data packet associated with the source with the quality of service level; and
transmitting the data packet to the peer network, wherein the peer network communicates the data packet based on the quality of service level associated with the data packet.

3. The method of claim 2, further comprising:
tracking an amount of data associated with the source being communicated by the first network; and
storing the amount in a peer usage tracking table.

4. The method of claim 3, wherein the quality of service level associated with the source dynamically changes in response to the amount stored in the peer usage tracking table exceeding a predetermined threshold.

5. The method of claim 2, further comprising;
calculating a cost associated with an amount of data associated with the source being communicated by the first network based on cost per unit associated with the source, the cost per unit being stored in the peer usage tracking table.

6. The method of claim 5, wherein the cost per unit associated with the source dynamically changes in response to the amount of data associated with the source exceeding a predetermined threshold.

7. The method of claim 2, wherein identifying the source and the content type associated with the data packet is performed using deep packet inspection and comparing a result of the deep packet inspection data to data stored in a registered quality of service peer table.

8. The method of claim 2, wherein the quality of service level associated with the source dynamically changes based on an amount of data associated with the source being communicated by the first network; and further comprising storing the amount in a peer usage tracking table.

9. The method of claim 2, further comprising marking the data packet with a user network identifier, wherein the user network identifier is utilized by the peer network to automatically authenticate the source of the data packet.

10. The method of claim 2, further comprising marking the data packet with a user network identifier, wherein the user network identifier is utilized to map the data packet to a service point of the peer network.

11. The method of claim 2, wherein the method is performed at a peering gateway configured to provide communication access between the first network and the peer network.

12. The method of claim 11, further comprising:
receiving, at the peering gateway, data associated with a peer usage tracking table and a registered quality of service peer table from an IP service controller of the first network.

13. The method of claim 12, further comprising:
utilizing, by the peering gateway, the data associated with a peer usage tracking table and a registered quality of service peer table in dynamically marking the data packet associated with the source with the quality of service level.

14. The method of claim 12, further comprising:
updating attribute values associated with the peer usage tracking table and the registered quality of service peer table from information received via a web interface.

15. An apparatus for providing advanced IP Service Peering, the apparatus comprising:
memory for storing data and executable instructions;
a network interface for communicating with at least one network; and
a processing unit operable to execute the executable instructions to:
identify a source and a content type associated with a data packet communicated from a first network to a peer network;
determine whether the source is a registered peer service;
identify, using a registered quality of service peer table, a quality of service level associated with the source in response to a determination that the source is a registered peer service;
dynamically mark the data packet associated with the source with the quality of service level;
transmit the data packet to the peer network, wherein the peer network communicates the data packet based on the quality of service level associated with the data packet;
monitor an amount of data associated with the source being communicated by the first network;
store the amount in a peer usage tracking table; and
calculate a cost associated with the amount of data associated with the source being communicated by the first network based on a cost per unit associated with the source, the cost per unit being stored in the peer usage tracking table.

16. The apparatus of claim 15, wherein the quality of service level associated with the source dynamically changes in response to the amount stored in the peer usage tracking table exceeding a predetermined threshold.

17. The apparatus of claim 15, wherein the cost per unit associated with the source dynamically changes in response to the amount of data associated with the source exceeding a predetermined threshold.

18. The apparatus of claim 15, wherein the processing unit is further operable to execute the executable instructions to mark the data packet with a user network identifier, wherein the user network identifier is utilized by the peer network to automatically authenticate the source of the data packet.

19. The apparatus of claim 15, wherein the processing unit is further operable to execute the executable instructions to utilize the user network identifier to map the data packet to a service point of the peer network.

20. The apparatus of claim 15, wherein the network interface is configured to receive data associated with the peer usage tracking table and the registered quality of service peer table from an IP service controller of the first network.
